(19) United States
(12) Patent Application Publication
(10) Pub. No.: US 2008/0178460 A1
(43) Pub. Date: Jul. 31, 2008

(54) Protected magnets and magnet shielding for processing microfeature workpieces, and associated systems and methods

(76) Inventors: Daniel J. Woodruff, Kalispell, MT (US); James J. Erickson, Kalispell, MT (US)

Correspondence Address: PERKINS COIE LLP/SEMITOOL, PO BOX 1208, SEATTLE, WA, 98111-1208, US

(21) Appl. No.: 11/700,263

(22) Filed: Jan. 29, 2007

(51) Int. Cl. H01S 4/00

(52) U.S. Cl. 29/592.1

(57) ABSTRACT

Protected magnets and magnet shielding for processing microfeature workpieces, and associated systems and methods are disclosed. A tool in accordance with one embodiment includes a process chamber having a process location for processing microfeature workpieces, a support positioned to carry a microfeature workpiece at the process location, a transfer device movable relative to the support to move the microfeature workpieces to and from the support, and a magnet positioned adjacent to the process chamber to magnetically orient materials applied to the microfeature workpieces. The tool can include other features, including an enclosure positioned around the magnet to chemically isolate the magnet from chemicals delivered to and carried in the process chamber, a shield positioned between the magnet and the motion path of the transfer device, magnetically conductive return paths positioned proximate to the magnet, and/or shields positioned around the motors carried by the tool.

### TECHNICAL FIELD

The present invention is related to protected magnets and magnet shielding for processing microfeature workpieces, and associated systems and methods. Systems in accordance with the invention include processing tools with magnets that are enclosed to protect them from the local chemical environment. Shielding is positioned between the magnets and other components of the system to protect the components from magnetic fields.

### BACKGROUND

Microelectronic devices are fabricated on and/or in microelectronic workpieces (e.g., wafers) using several different processing apparatuses or tools. Many such processing tools have a single processing station that performs one or more procedures on the workpieces. Other processing tools have a plurality of processing stations that perform a series of different procedures on individual workpieces or batches of workpieces. The workpieces are often handled by automatic handling equipment (e.g., robots or transfer devices) because microelectronic fabrication requires very precise positioning of the workpieces, and/or due to conditions that are not suitable for human access (e.g., vacuum environments, high temperature environments, chemical environments, clean environments, etc.).

An increasingly important category of processing tool is a plating tool that plates metal and other materials onto workpieces. Existing plating tools use automatic handling equipment to handle the workpieces because the position, movement and cleanliness of the workpieces are important parameters for accurately plating materials onto the workpieces. The plating tools can be used to plate metals and other materials (e.g., ceramics or polymers) in the formation of contacts, interconnects and other components of microelectronic devices. For example, copper plating tools are used to form copper contacts and interconnects on semiconductor wafers, field emission displays, read/write heads and other types of microelectronic workpieces. A typical copper plating process involves depositing a copper seed layer onto the surface of the workpiece using chemical vapor deposition (CVD), physical vapor deposition (PVD), electroless plating processes, or other suitable methods. After forming the seed layer, copper is plated onto the workpiece by applying an appropriate electrical field between the seed layer and an anode in the presence of an electrochemical plating solution. The workpiece is then cleaned, etched and/or annealed in subsequent procedures before transferring the workpiece to another tool or apparatus.

In at least some instances, it is desirable to expose the material being deposited on the workpiece to a magnetic field that orients the material in a particular direction relative to coordinates of the workpiece. For example, it is desirable to plate a ferromagnetic material on the workpiece with a uniform magnetic orientation when the workpiece is to be used for computer hard drive components. It is important in such cases to orient the ferromagnetic material properly with respect to the workpiece by placing a strong magnet proximate to the process chamber during the deposition process. However, one drawback with the foregoing approach is that the effects of the magnet on the other devices and components of the tool are typically unknown and/or potentially harmful to those devices. In addition, the environment in the tool may have potentially harmful effects on the magnet.

In light of the foregoing, it is desirable to provide protected and/or shielded magnets for processing microfeature workpieces. It would also be desirable to incorporate such features into a processing tool without having a significant effect on other components of the tools, and without significantly increasing the size of the tool, as doing so will increase the footprint of the tool and therefore the amount of (expensive) clean room space occupied by the tool.

### SUMMARY

The present invention provides processing tools and associated methods directed to protecting a magnet used during microfeature workpiece processing, and/or protecting other components of the tool from the effects of the magnet. The magnet is positioned adjacent to a process chamber of the tool to magnetically orient materials applied to a microfeature workpiece. An enclosure is positioned around the magnet to isolate the magnet from chemicals delivered to and carried in the process chamber, thus protecting the magnet. In another arrangement, the tool includes a transfer device that moves workpieces to and from the chamber. A magnetically conductive shield is positioned between the magnet and the motion path of the transfer device to shield the transfer device from the magnetic field generated by the magnet. This arrangement protects the transfer device from interference by the magnet. The shield used to protect the transfer device doubles as (or can be supplemented with) a magnetically conductive return path that orients (e.g., straightens) the magnetic field within the process chamber to more consistently and reliably orient materials deposited on the workpiece at the chamber. Devices other than the transfer device may also be protected from the effects of the magnet. For example, motors used to drive an associated workpiece support (which carries the workpiece at the process chamber) are shielded, as is a motor that agitates the fluid within the process chamber.

### BRIEF DESCRIPTION OF THE DRAWINGS

FIG. 1 is a top isometric view of a tool having one or more processing stations with magnets arranged in accordance with embodiments of the invention.

FIG. 2 is a partially exploded illustration of a tool structure including decks configured to support tool components in accordance with an embodiment of the invention.

FIG. 3 is a partially cut-away, top isometric view of the tool structure shown in FIG. 2, with a magnet assembly installed in accordance with an embodiment of the invention.

FIG. 4 is a partially schematic, isometric illustration of the tool structure shown in FIG. 3, with the tool deck carrying a processing chamber and a support in accordance with an embodiment of the invention.

### DETAILED DESCRIPTION

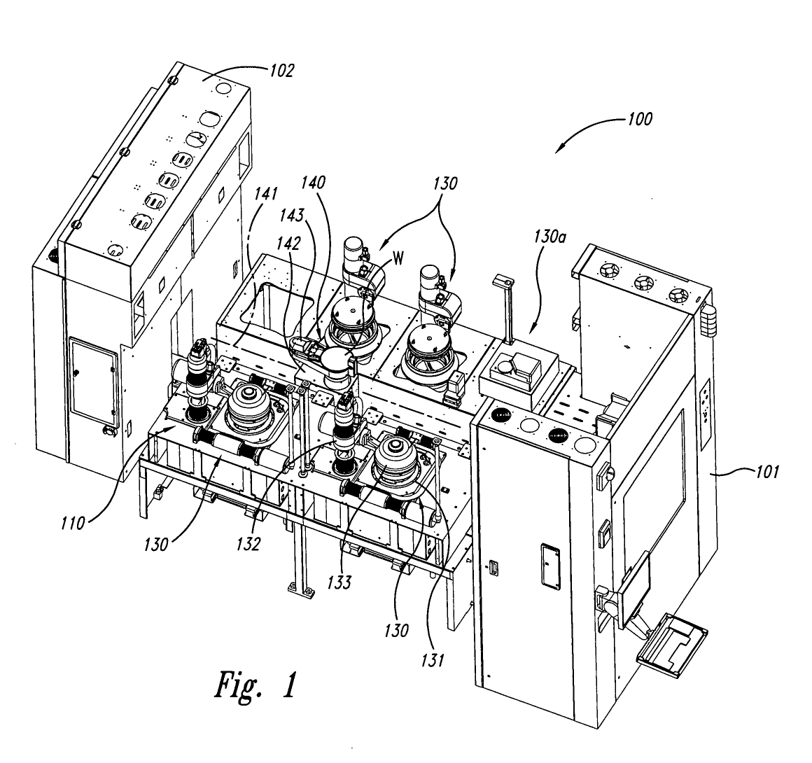

The following description discloses the details and features of several embodiments of tools for processing microfeature workpieces in the presence of magnetic fields, and methods for making and using such devices. The terms “microfeature workpiece” and “workpiece” refer to substrates on and/or in which micro-devices are formed. Typically, micro-devices include microelectronic circuits or components, thin-film recording heads, data storage elements, micro-fluidic devices, and other products. Micro-machines and/or micromechanical devices are included within this definition because they are manufactured in much the same manner as integrated circuits. The substrates can be semiconductive pieces (e.g., silicon wafers or gallium arsenide wafers), non-conductive pieces (e.g., various substrates), or conductive pieces (e.g., doped wafers). It will be appreciated that several of the details set forth below are provided to describe the following embodiments in a manner sufficient to enable a person skilled in the art to make and use the disclosed embodiments. Several of the details and advantages described below, however, may not be necessary to practice certain embodiments of the invention. Additionally, the invention may also include other embodiments that are also within the scope of the claims, but are not described in detail with reference to FIGS. 1-4.

FIG. 1 is a partially schematic, isometric illustration of a tool 100 that performs one or more wet chemical or other processes on microfeature workpieces W. The tool 100 includes a housing or cabinet (removed for purposes of illustration) that encloses a deck 110. The deck 110 supports a plurality of processing stations 130 and a transport system 140. The stations 130 can include rinse/dry chambers, cleaning capsules, etching capsules, electrochemical deposition chambers, annealing chambers, or other types of processing chambers. Individual processing stations 130 include a vessel, reactor, or chamber 131 and a workpiece support 132 (for example, a lift-rotate unit) for supporting an individual microfeature workpiece W during processing at the chamber 131. The transport system 140 moves the workpiece W to and from the chamber 131. Accordingly, the transport system 140 includes a transfer device 142 or robot that moves along a linear guide path 141 to transport individual workpieces W within the tool 100. The tool 100 further includes a workpiece load/unload unit 101 having a plurality of containers for holding the workpieces W as they enter and exit the tool 100.

In operation, the transfer device 142 has a first carrier 143 with which it carries the workpieces W from the load/unload unit 101 to the processing stations 130 according to a predetermined workflow schedule within the tool 100. Typically, each workpiece W is initially aligned at a pre-aligner station 130a before it is moved sequentially to other processing stations 130. At each processing station 130, the transfer device 142 transfers the workpiece W from the first carrier 143 to a second carrier 133 located at the workpiece support 132. The second carrier 133 then carries the workpiece W for processing at the corresponding process chamber 131. A controller 102 receives inputs from an operator and, based on the inputs, automatically directs the operation of the transfer device 142, the processing stations 130, and the load/unload unit 101.

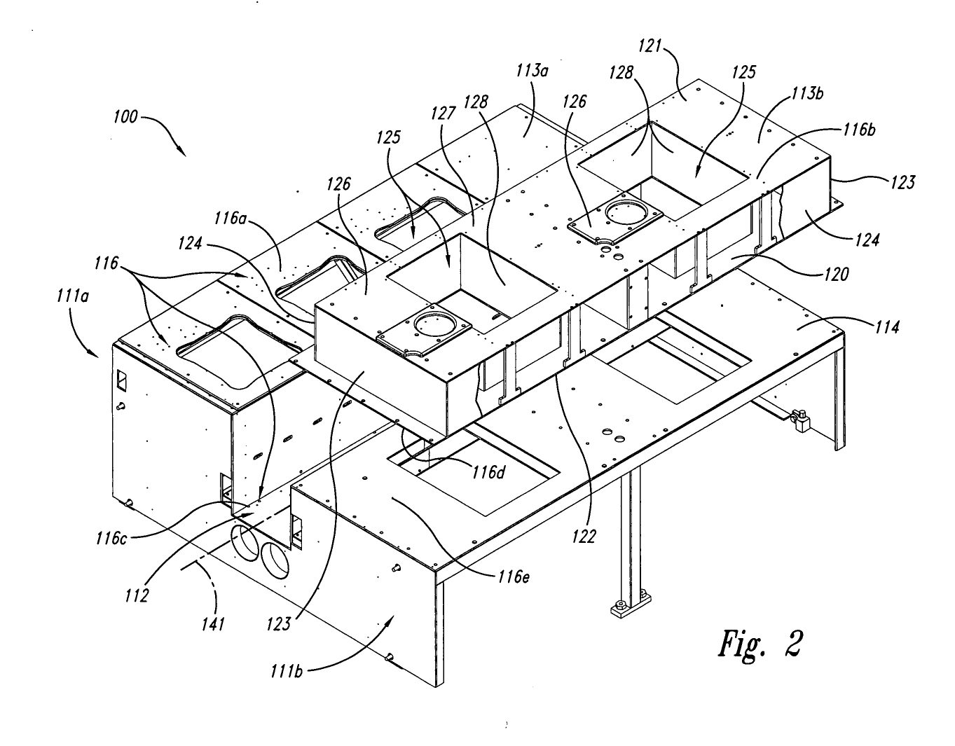

FIG. 2 is a partially exploded, isometric view of a portion of the underlying structure of the tool 100 shown in FIG. 1. The deck 110 of the tool 100 includes a first portion 111a having a first deck surface 113a, and a second portion 111b having a second deck surface 113b. The deck portions 111a, 111b are positioned on opposite sides of a transfer device “gulley” 112. The transfer device gulley 112 supports the transfer device 142 (FIG. 1) for motion along the guide path 141 so that the transfer device 142 can access processing stations carried by either the first deck surface 113a or the second deck surface 113b. In some instances, the deck surfaces 113a, 113b are at different elevations (e.g., with the second deck surface 113b higher than the first deck surface 113a), and in such cases, the transfer device 142 (FIG. 1) is configured to access processing stations at both elevations.

The first and second deck surfaces 113a, 113b include chamber mounts 127 for carrying processing chamber components, and support mounts 126 for carrying workpiece support components. Each deck surface 113a, 113b also includes a chamber opening 125 that accommodates a chamber 131 (FIG. 1) or a portion of the chamber 131 that extends below the corresponding deck surface. The deck surfaces 113a, 113b and the transfer device gulley 112 have registration features 116, including first registration features 116a, second registration features 116b, and third registration features 116c. The registration features 116 include precision mating elements (e.g., fixed alignment pegs and corresponding holes) that provide for precise alignment between the components of the tool 100. Accordingly, transfer device components engaged with the third registration features 116c (in the transfer device gulley 112) will be in precise alignment with processing station components engaged with the first registration features 116a (at the first deck surface 113a), and with processing station components engaged with the second registration features 116b (at the second deck surface 113b). This arrangement reduces or eliminates misalignments between the transfer device 142 (FIG. 1) and the processing stations 130 (FIG. 1).

The second portion 111b of the deck 110 includes an enclosure 120 carried by a subdeck surface 114. Accordingly, the enclosure 120 includes fourth registration features 116d that engage with fifth registration features 116e carried by the subdeck surface 114. This arrangement preserves the precise alignment between transfer device components in the transfer device gulley 112, and processing station components carried at the second deck surface 113b.

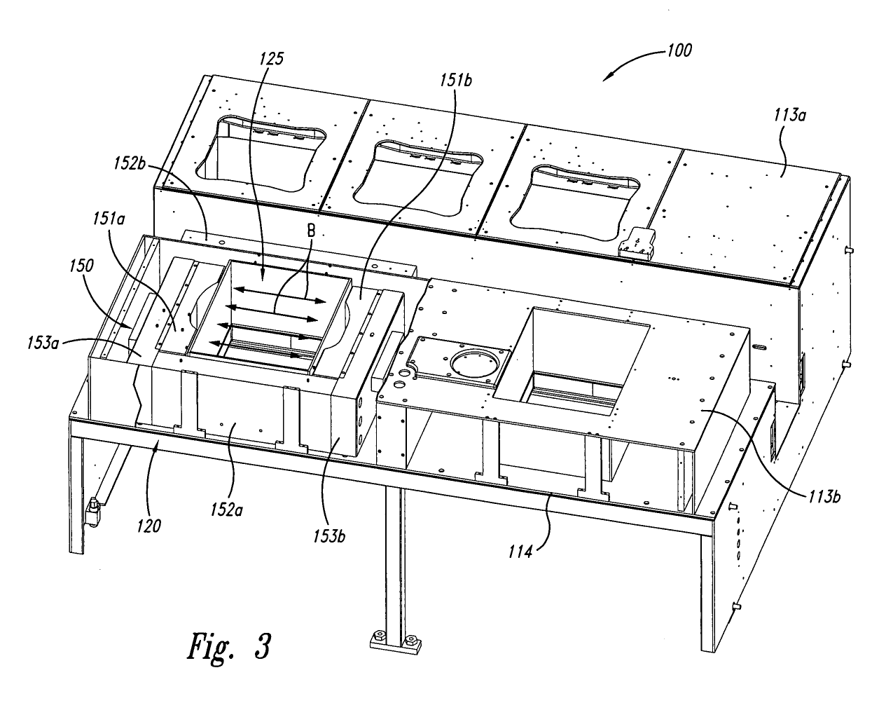

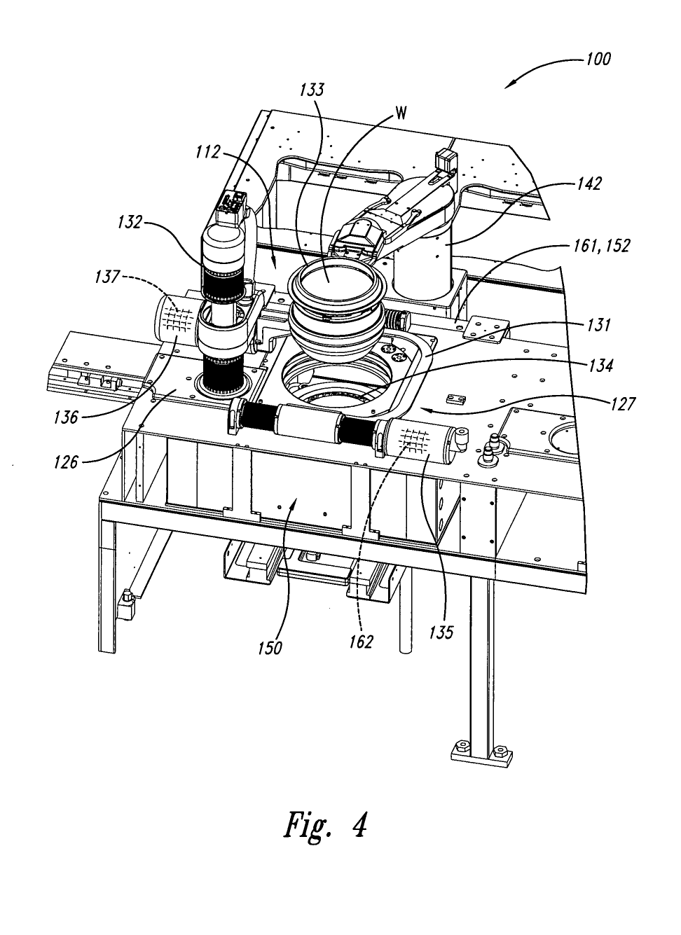

In addition to maintaining the registration between transfer device components and processing station components, the enclosure 120 protects components housed within it from the chemical environment present in the tool 100. These components include relatively large, powerful (and therefore heavy) magnets described in further detail below with reference to FIGS. 3 and 4. In the illustrated embodiment, the enclosure 120 includes a base 122, a top 121 (the external surface of which also corresponds to the second deck surface 113b), opposing end walls 123, and opposing side walls 124 (shown partially cut-away). The enclosure 120 is also defined by chamber opening walls 128 that surround the chamber opening 125. This box-type arrangement forms a structurally stiff enclosure 120, suitable for carrying heavy components, including the large magnets. In particular, the sidewalls 124, end walls 123, and/or chamber opening walls 128 provide a load path between the base 122 and the top 121, allowing the top 121 to supplement the support provided by the base 122. Furthermore, the base 122, side walls 124, end walls 123, chamber opening walls 128, and top 121 are connected to each other in such a manner as to form a chemical-tight (or at least chemically resistant) boundary around the magnets. In a particular arrangement, the components of the enclosure 120 are welded together and coated with a gas- and/or liquid-tight sealant. Suitable sealants include powder-coat polymer paints. This arrangement protects components within the enclosure 120 from the chemical environment outside the enclosure 120. In particular, this arrangement protects the magnets, which are typically formed from magnetite or other materials that are otherwise very susceptible to corrosion, from chemicals outside the enclosure 120.

FIG. 3 is a top isometric view of the deck arrangement shown in FIG. 2, with the enclosure 120 mounted to the subdeck surface 114, and with a portion of the second deck surface 113b cut away to expose components within the enclosure 120. These components include a magnet assembly 150, that in turn includes a first magnet 151a positioned on one side of the chamber opening 125, and a second magnet 151b positioned on the opposite side of the chamber opening 125. Corresponding magnet supports 153a and 153b secure the first and second magnets 151a, 151b in position.

The magnetic flux lines between the two magnets 151a, 151b tend to bulge outwardly and/or stray from the region between the two magnets, in the absence of measures taken to direct the flux lines. This can produce adverse effects, including (a) a skewed magnetic field in any process chamber located between the magnets 151a, 151b, and/or (b) interference with motors and/or other electronic equipment carried by the tool. In at least some cases, the skewed magnetic field adversely affects the uniformity of the material deposited on a workpiece in the process chamber, and the interference adversely affects the rate and/or accuracy with which components in the tool operate. Aside from the magnets 151a, 151b and possibly the magnet supports 153a, 153b, most, if not all of the components making up the deck 110 are generally non-magnetic. For example, the deck surfaces 113a, 113b, the subdeck 114, and the enclosure 120 are typically formed from stainless steel (e.g., a 300-series stainless steel, such as 304 stainless steel) or another corrosion-resistant non-magnetic material, and are generally relatively thin. Accordingly, they have little or no effect on the magnetic flux lines between the magnets 151a, 151b.

To address the foregoing, the illustrated magnet assembly 150 includes a first magnetic return path 152a positioned between the first and second magnets 151a, 151b on one side of the chamber opening 125, and a second magnetic return path 152b positioned on the opposite side of the chamber opening 125. The first and second magnetic return paths 152a, 152b align the magnetic flux lines between the first magnet 151a and the second magnet 151b to be generally parallel to the return paths 152a, 152b and generally transverse (e.g., perpendicular) to the first and second magnets 151a, 151b, as indicated by magnetic flux lines B. One advantage of this arrangement is that the magnetic flux lines B will have a known and generally consistent orientation across the chamber opening 125 and accordingly throughout a process chamber 131 (FIG. 1) installed in the chamber opening 125. This feature is expected to produce more uniform deposition results for microfeature workpieces that are processed at the process chamber 131.

Another feature of the illustrated magnet assembly 150 is that the second magnetic return path 152b, in addition to aligning the magnetic flux lines in the manner described above, acts as a shield between the magnets 151a, 151b and the transfer device gulley 112. As discussed further with reference to FIG. 4, the shield can form part of an overall shielding arrangement that reduces the effects of the magnetic fields created by the magnets 151a, 151b on other components within the tool 100.

Still another feature of the illustrated magnet assembly 150 is that it is arranged to provide for long component life spans, ease of manufacturability, and ease of maintenance. For example, the first magnetic return path 152a is housed in the enclosure 120. This component is typically formed from a ferromagnetic material and accordingly may be susceptible to corrosion without the protection of the enclosure 120. In some embodiments, the second magnetic return path 152b is also placed in the enclosure 120 to provide similar protection. In the embodiment illustrated in FIG. 3, however, the second magnetic return path 152b is positioned exterior to the enclosure 120, and out of contact with the first and second magnets 151a, 151b. In this position, the second magnetic return path 152b can still direct the magnetic flux lines B in the desired manner, and can also enhance manufacturing and maintenance operations. For example, by not attaching the second magnetic return path 152b to the other components of the magnet assembly 150, the magnet assembly 150 has an open-ended shape, formed by the two magnets 151a, 151b, the magnet supports 153a, 153b, and the first magnetic return path 152a. This configuration can be easily installed into the enclosure 120 by sliding it toward the transfer device gully 112, without disturbing the second deck surface 113b. If necessary, this portion of the magnetic assembly 150 can be removed by sliding it away from the transfer device gully 112 and out of the enclosure 120. The second magnetic return path 152b can be separately protected from the chemical environment within the tool 100 by coating it with an appropriate sealant/coating, as described above in the context of the enclosure 120. If it becomes necessary to replace the second magnetic return path 152b, the replacement operation is completed without disturbing the enclosure 120.

FIG. 4 illustrates the tool 100 with a process chamber 131 positioned at one of the chamber mounts 127 so as to extend into a corresponding chamber opening (hidden by the process chamber 131). A support 132 is positioned at a corresponding support mount 126. The support 132 includes a second carrier 133 that carries a workpiece W in contact with processing liquid in the chamber 131. In this particular arrangement, the process chamber 131 includes an agitator 134 that agitates the processing fluid adjacent to the workpiece. Accordingly, the station 130 includes an agitator drive motor 135 that drives the agitator 134, and a carrier drive motor 136 that drives the second carrier 133. In order to protect these motors from the potentially interfering effects of the magnet assembly 150, the agitator drive motor 135 includes a magnetically conductive agitator motor shield 162, and the carrier drive motor 136 includes a magnetically conductive carrier motor shield 137.

The illustrated tool 100 also includes a transfer device shield 161 positioned between the magnet assembly 150 and the transfer device gulley 112. In this manner, the motors carried by the transfer device 142 are shielded from the effects of the magnet assembly 150. In a particular arrangement, the same structure functions as both the transfer device shield 161 and the second magnetic return path 152b. This configuration preserves the compact configuration of the tool 100 (by combining multiple functions in a single structure), thus reducing the amount of expensive clean-room floor space occupied by the tool 100. In other embodiments, the transfer device shield 161 and the second magnetic return path 152b include separate structures.

From the foregoing, it will be appreciated that specific embodiments of the invention have been described herein for purposes of illustration, but that various modifications may be made without deviating from the invention. For example, the transfer device shield 161 which can double as the second magnetic return path 152b can be located inside the enclosure 120, rather than outside the enclosure as is shown in FIGS. 3 and 4. Or, the second magnetic return path 152b can be located within the enclosure 120, and the transfer device shield 161 can be located outside the enclosure 120. The materials and compositions of the components described above may be different in other embodiments. For example, the enclosure 120 and/or other deck components may include plastics or other non-conductive, chemically resistant materials. The shields positioned around the support motor and/or the agitator motor can be located remote from the motors while still providing a shielding function. Shielding may be provided around components other than the motors identified above, for example, around a spin motor carried by the support to spin the workpiece during processing. Certain aspects of the invention described in the context of particular embodiments may be combined or eliminated in other embodiments. For example, the tool 100 shown in the Figures may include more or fewer processing stations in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited except as by the appended claims.

I/We claim:

1. A tool for processing microfeature workpieces, comprising:
a process chamber having a process location for processing microfeature workpieces;
a support positioned to carry a microfeature workpiece at the process location;
a transfer device movable relative to the support to move microfeature workpieces to and from the support;
a magnet positioned adjacent to the process chamber to magnetically orient materials applied to the microfeature workpieces; and
an enclosure positioned around the magnet to chemically isolate the magnet from chemicals delivered to and carried in the process chamber.

2. The tool of claim 1 wherein the enclosure includes a base below the magnet, walls connected to the base, and a top connected to the walls above the magnet, and wherein the walls and the top form a structural load path with the base.

3. The tool of claim 2 wherein the support and the process chamber are carried by the top.

4. The tool of claim 3 wherein the base has a fixed registration with a transport guide along which the transfer device moves, and wherein the top has a fixed registration with the base.

5. The tool of claim 2 wherein the base, walls and top are welded together and coated with a gas- and liquid-tight sealant.

6. The tool of claim 1 wherein the magnet includes first and second magnets positioned on opposing sides of the process chamber.

7. The tool of claim 6, further comprising a first magnetically conductive return path positioned between the first and second magnets within the enclosure, and a second magnetically conductive return path positioned between the first and second magnets external to the enclosure.

8. The tool of claim 7 wherein the second magnetically conductive return path is positioned between the transfer device and the first and second magnets to shield the transfer device from a magnetic field created by the magnets..

9. The tool of claim 1 wherein the transfer device is movable along a generally linear guide path, and wherein the tool further comprises a deck having a first portion on one side of the guide path that carries the process chamber, and a second portion on the other side of the guide path that carries an additional process chamber.

10. The tool of claim 9 wherein the first portion is at a first elevation and wherein the second portion is at a second elevation below the first elevation.

11. The tool of claim 1, further comprising a deck that carries the process chamber and the support, and wherein the deck is formed from a non-magnetic material.

12. The tool of claim 11 wherein the deck is formed from a 300-series stainless steel.

13. A tool for processing microfeature workpieces, comprising:
a process chamber having a process location for processing microfeature workpieces;
a support positioned to carry a microfeature workpiece at the process location;
a transfer device movable relative to the support along a motion path to move microfeature workpieces to and from the support;
a magnet positioned adjacent to the process chamber to magnetically orient materials applied to the microfeature workpieces; and
a magnetically conductive shield positioned between the magnet and the motion path to shield the transfer device from the magnetic field of the magnet.

14. The tool of claim 13 wherein the magnet includes two spaced-apart magnets, and wherein the shield is positioned transverse to the two magnets.

15. The tool of claim 14 wherein the shield is spaced apart from the two magnets.

16. The tool of claim 14, further comprising a deck carrying the process chamber, the support and the transfer device, and wherein the deck includes a wall positioned between the process chamber and the motion path, with the magnets positioned on one side of the wall and the shield spaced apart from the magnets and positioned on an opposite side of the wall.

17. The tool of claim 16 wherein the wall and the shield are formed from different materials, and wherein the material forming the wall is generally non-magnetic.

18. The tool of claim 16 wherein the wall forms at least a portion of a gas- and fluid-tight enclosure around the magnet.

19. The tool of claim 13 wherein the support includes a base, a workpiece carrier movable relative to the base, and a support motor coupled to the workpiece carrier to move the workpiece carrier relative to the base, and wherein the shield is a first shield, and wherein the tool further comprises a second shield positioned around the motor, between the motor and the magnet.

20. The tool of claim 13 wherein the shield is a first shield, and wherein the tool further comprises:
an agitator positioned to agitate process fluid at the process location;
a motor coupled to the agitator to move the agitator relative to the process location; and
a second shield positioned around the motor, between the motor and the magnet.

21. A tool for processing microfeature workpieces, comprising:
a process chamber having a process location for processing microfeature workpieces;
a support positioned to carry a microfeature workpiece at the process location;
a transfer device movable relative to the support along a motion path to move microfeature workpieces to and from the support;
first and second magnets positioned on first and second opposing sides of the process chamber to magnetically orient materials applied to the microfeature workpieces; and
first and second magnetically conductive return paths positioned on opposing third and fourth sides of the process chamber to orient the magnetic field of the magnets generally parallel to the return paths.

22. The tool of claim 21 wherein the first return path includes a first magnetically conductive member in contact with the first and second magnets, and wherein the second return path includes a second magnetically conductive member spaced apart from the first and second magnets and spaced apart from the first magnetically conductive member.

23. The tool of claim 21, further comprising a deck carrying the process chamber, the support and the transfer device, and wherein the deck includes a wall positioned between the process chamber and the motion path, with the first and second magnets positioned on one side of the wall and the second return path spaced apart from the magnets and positioned on an opposite side of the wall.

24. The tool of claim 23 wherein the wall and the shield are formed from different materials, and wherein the material forming the wall is generally non-magnetic.

25. The tool of claim 24 wherein the wall is formed from a 300-series stainless steel.

26. A method for processing microfeature workpieces, comprising:
moving a microfeature workpiece from a transfer device to a support;
carrying the microfeature workpiece with the support at a process location of a process vessel;
processing the microfeature workpiece at the process location while orienting material in the process chamber with a magnet positioned proximate to the process chamber; and
shielding the transfer device from a magnetic field emanating from the magnet with a magnetically conductive shield positioned between the magnet and the transfer device.

27. The method of claim 26 wherein the magnet includes two magnets positioned on opposing sides of the process chamber, and wherein the method further comprises orienting magnetic field lines at the process location with the magnetically conductive shield.

28. The method of claim 26, further comprising chemically isolating the magnet from chemicals delivered to and carried in the process chamber.

29. The method of claim 26 wherein moving a microfeature workpiece from a transfer device to a support includes placing the workpiece on a carrier of the support, and wherein the method further comprises moving the workpiece to the process location with the carrier by activating a motor that is coupled to the carrier and that is shielded from the magnetic field emanating from the magnet.

30. The method of claim 26, further comprising agitating processing fluid adjacent to the workpiece by driving an agitator with a motor that is shielded from the magnetic field emanating from the magnet.

31. A method for processing microfeature workpieces, comprising:
moving a microfeature workpiece from a transfer device to a support;
carrying the microfeature workpiece with the support at a process location of a process chamber, the process location being between first and second magnets;
processing the microfeature workpiece at the process location while orienting material in the process chamber with the first and second magnets; and
orienting a magnetic field between the first and second magnets with first and second magnetically conductive return paths positioned between the first and second magnets, and with the process location being between the first and second return paths.

32. The method of claim 31 wherein processing the microfeature workpiece includes depositing magnetically-sensitive material on the microfeature workpiece.

33. The method of claim 32, further comprising agitating processing liquid in the process chamber proximate to the process location by activating an agitator with an agitator motor that is shielded from the magnetic field.

34. The method of claim 31 wherein orienting the magnetic field includes orienting the magnetic field with a first magnetically conductive return path located within a sealed enclosure that also contains the magnet, and with a second magnetically conductive return path located external to the sealed enclosure.

35. A method for manufacturing a tool for processing microfeature workpieces, comprising:
positioning a processing chamber along a transfer device guide path;
locating a transfer device for movement along the guide path, the transfer device having a first carrier;
positioning a workpiece support proximate to the processing chamber, the support having a second carrier accessible to the first carrier of the transfer device;
positioning a magnet at the processing chamber to orient magnetic materials carried in the processing chamber; and
positioning a magnetically conductive shield between the magnet and the guide path to direct magnetic field lines away from the transfer device.

36. The method of claim 35 wherein positioning the processing chamber includes carrying the processing chamber at a deck of the tool, and wherein positioning the workpiece support includes carrying the workpiece support at the deck of the tool.

37. The method of claim 35 wherein positioning a workpiece support includes positioning a workpiece support having a magnetically shielded motor coupled to the second carrier.

38. The method of claim 35, further comprising positioning the magnet in a sealed enclosure proximate to the processing chamber.

39. The method of claim 38, further comprising positioning the magnetically conductive shield external to the enclosure.
